(19) United States
(12) Patent Application Publication
(10) Pub. No.: US 2012/0078663 A1
(43) Pub. Date: Mar. 29, 2012

(54) UNIVERSAL PATIENT RECORD CONVERSION TOOL

(75) Inventor: Robert H. Lorsch, Los Angeles, CA (US)

(73) Assignee: MYMEDICALRECORDS.COM, INC., Los Angeles, CA (US)

(21) Appl. No.: 13/246,948

(22) Filed: Sep. 28, 2011

Related U.S. Application Data
(60) Provisional application No. 61/387,429, filed on Sep. 28, 2010.

(51) Int. Cl. G06Q 50/24; H04N 1/00

(52) U.S. Cl. 705/3; 358/403

(57) ABSTRACT

A system includes a health care provider computer operatively connected over a network to a web server, the web server providing a health care provider portal and an applet. The applet is configured to convert patient records in a first format to patient records in a second format. The first format may be associated with a practice management system, may be an electronic health record format, may be a personal health record format, or other type of format.

### CROSS-REFERENCE TO RELATED APPLICATIONS

This application claims priority under 35 U.S.C. §119 to provisional application Ser. No. 61/387,429 filed Sep. 28, 2010, herein incorporated by reference in its entirety.

### FIELD OF THE INVENTION

The present invention relates to patient records, such as those associated with practice management systems as well as electronic health records (EHRs) and personal health records (PHRs).

### BACKGROUND OF THE INVENTION

In recent times, much emphasis has been placed on electronic medical records (EMRs), electronic health records (EHRs), personal health records (PHRs), and the like. There is recognition that improved health care and reduced health care costs may be provided to a patient if electronic medical records associated with the patient may be communicated to the particular health care provider in need of the electronic medical records. Therefore, much effort has been placed on creating electronic medical records.

Yet such an approach overlooks a critical problem in health care today. Many patient records are simply not in electronic form. Thus, for all the talk of “paperless” offices being made possible by EMR systems, the reality is that many doctors, particularly solo and small group practitioners, still have not adopted EMRs in their practice. Moreover, conversion to electronic records can be time-consuming and costly. Therefore, conversion to electronic records remains a problem. What is needed are methods and systems that facilitate conversion from paper records to electronic records.

Another problem relates to patients ability to access records. Patients are more and more frequently requesting access to their records from multiple health care providers. Pulling files and charts in response to such requests may be time consuming and expensive. What is needed is a better to create and manage electronic records that may be shared with patients.

### SUMMARY OF THE INVENTION

Therefore, it is a primary object, feature, or advantage of the present invention to improve over the state of the art.

It is a further object, feature, or advantage of the present invention to provide for seamless conversion of patient records from practice management systems, EHRs, and PHRs and other types of data sources.

Yet another object, feature, or advantage of the present invention is to allow for the healthcare provider to quickly and easily, yet securely, communicate records associated with an individual to the individual.

A still further object, feature, or advantage is to provide a web site for management of health care records which is modular in design, to allow for additional features and functions to be integrated easily and rapidly.

These and/or other objects, features, or advantages of the present invention will become apparent from the specification and claims that follow. No single embodiment need exhibit every object, feature, or advantage provided herein. The present invention is not to be limited to or by these objects, features, or advantages.

According to one aspect of the present invention, a system is provided. The system includes a health care provider computer operatively connected over a network to a web server, the web server providing a health care provider portal and an applet. The applet is configured to convert patient records in a first format to patient records in a second format. The first format may be associated with a practice management system, may be an electronic health record format, may be a personal health record format, or other type of format, such as, but not limited to HL7.

According to another aspect of the present invention, a web server is programmed to provide a health care provider portal to a health care provider and an applet to the health care provider wherein the applet is configured to convert patient records from a first format to a second format.

According to another aspect of the present invention, a method for converting paper records to electronic record includes executing an applet on a computer to access patient records stored in a first format and convert the patient records to a second format, wherein both the first format and the second format include a patient name and a unique patient identifier. The method further includes generating a bar code containing the unique patient identifier from the second format and printing the bar code on a second sheet. The method further includes scanning a plurality of paper pages comprising the cover sheet followed by at least one additional page of paper records associated with the patient identified with the unique patient identifier from the second format. The method further includes storing in data storage associated with and accessible by a web server an electronic copy of the at least one additional page of paper records such that the electronic copy is associated with the unique patient identifier.

### BRIEF DESCRIPTION OF THE DRAWINGS

FIG. 1 illustrates one example of a system of the present invention configured for use with a practice management system.

FIG. 2 illustrates the system of the present invention configured for use with electronic health records and/or personal health records.

FIG. 3 illustrates one example of the process of mapping patient data in a first format to patient data in a second format as a part of a conversion process.

### DETAILED DESCRIPTION

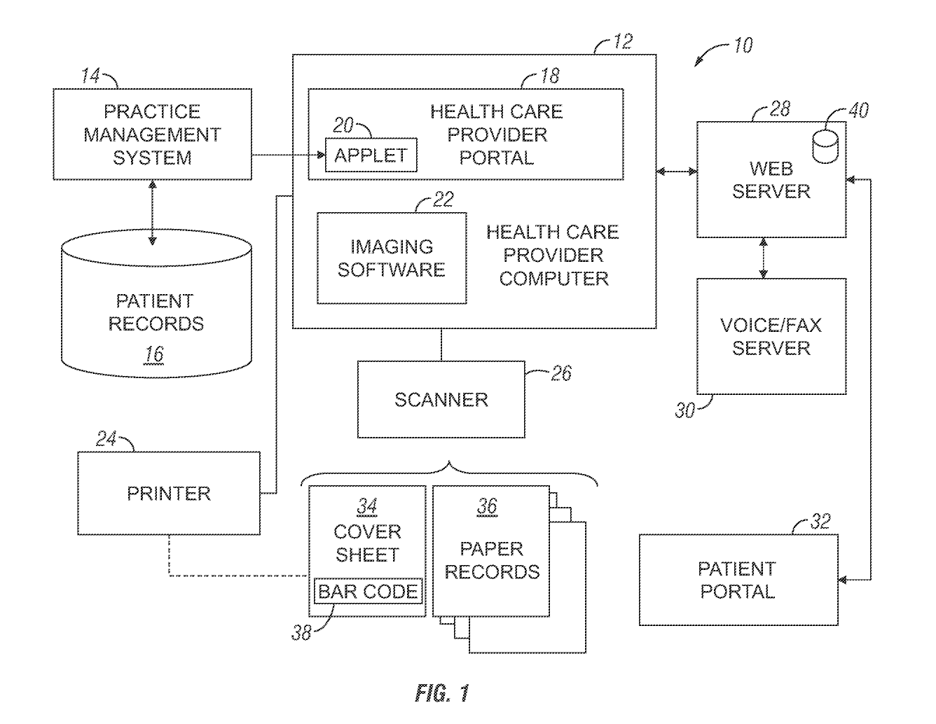

FIG. 1 illustrates one example of a system of the present invention configured for use with a practice management system. In FIG. 1, a system 10 is shown. The system 10 includes a health care provider computer 12. The health care provider computer 12 may use a web browser or other software application to access a health care provider portal 18. The health care provider portal 18 is communicated from a web server 28 over a network connection. An applet 20 may also be provided by the web server 28 and executed on the health care provider computer 20. The applet 20 may be stored on a computer readable storage medium associated with the web server 28 as well as the health care provider computer 20.

The practice associated with the health care provider computer 12 may configure the applet 20 to connect to their practice management system 14 and/or its associated data or patient records 16. It is to be understood that the practice management system 14, although containing information about a patient does not necessarily contain medical records. After a one-time configuration, patient records may be uploaded on demand from the patient records database 16 into the portal 18. The portal 18 can then make use of the data from the patient records 16 for various purposes. For example, patient bar codes 38 can be immediately created (such as by using printer 24 to print the bar codes 38 on a cover sheet 34) for the purpose of scanning records into the patient's virtual chart (such as scanning with scanner 26 the cover sheet 34 with bar code 38 followed by the paper records 36), and so that patient records can be searched and retrieved through the health care provider portal 18. This open integration may be used with any file format including, without limitation, data export .csv, .txt, flat file or HL7. Thus, a universal patient record conversion tool is provided.

Once scanned, the bar code allows the paper records to be associated with the proper patient. The electronic records may then be stored in a database 40 which is accessible by web server 28. This allows the health care provider portal 18 to access the electronic records in the future. In addition, where a patient portal 32 is present, this allows the patient to access their own records as well. The patient portal 32 may only provide for accessing those records provided by this health care provider, or alternatively may also include records from multiple health care providers as described in U.S. Published Patent Application No. US 2007/0061169 A1, U.S. Published Patent Application No. US 2007/0061170 A1, U.S. Published Patent Application No. US 2007/0233519 A1, U.S. Published Patent Application No. US 2009/0007237, U.S. Published Patent Application No. 2009/0055222 A1, U.S. Published Patent Application No. 20090055894, all of which are hereby incorporated by reference in their entireties.

It is to be understood that practice management systems are generally in use by health care providers regardless of the availability of electronic health records. Practice management systems may primarily includes basic patient information and billing information as opposed to actual medical records. The medical records (where not electronic) would typically be contained within paper files. Thus, the present invention assists a health care provider in the process of conversion to electronic records from paper records.

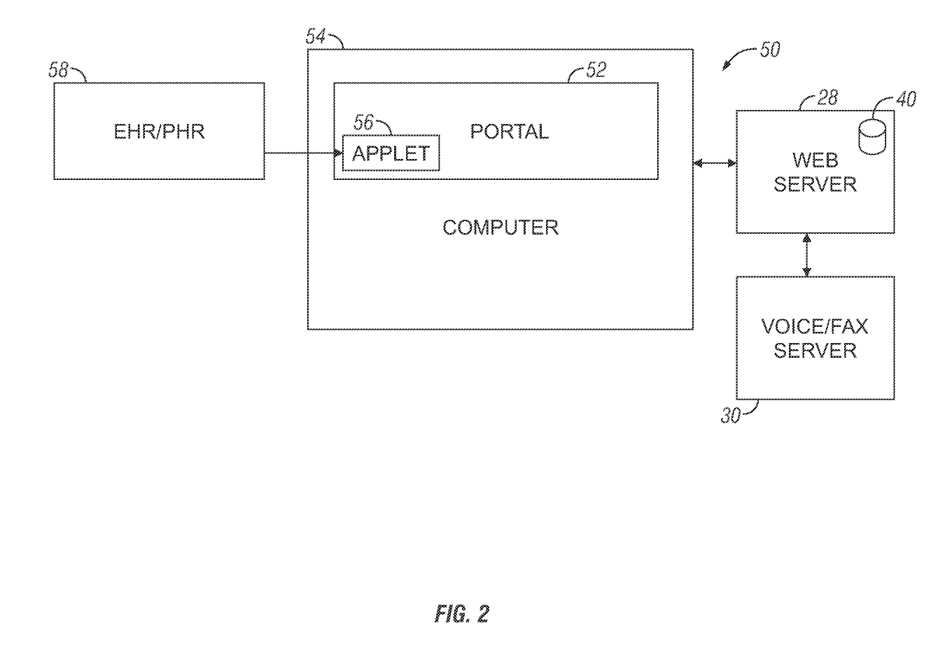

FIG. 2 illustrates the system of the present invention configured for use with electronic health records and/or personal health records. In FIG. 2, a system 50 is shown. A computer 54 is provided which accesses portal 52 provided over a network connection from the web server 28. The applet 56 allows for the conversion of electronic health records or personal health records into a format which may be stored on the database 40 which is operatively connected to the web server 40. A voice/fax server 30 is also operatively connected to the web server 28.

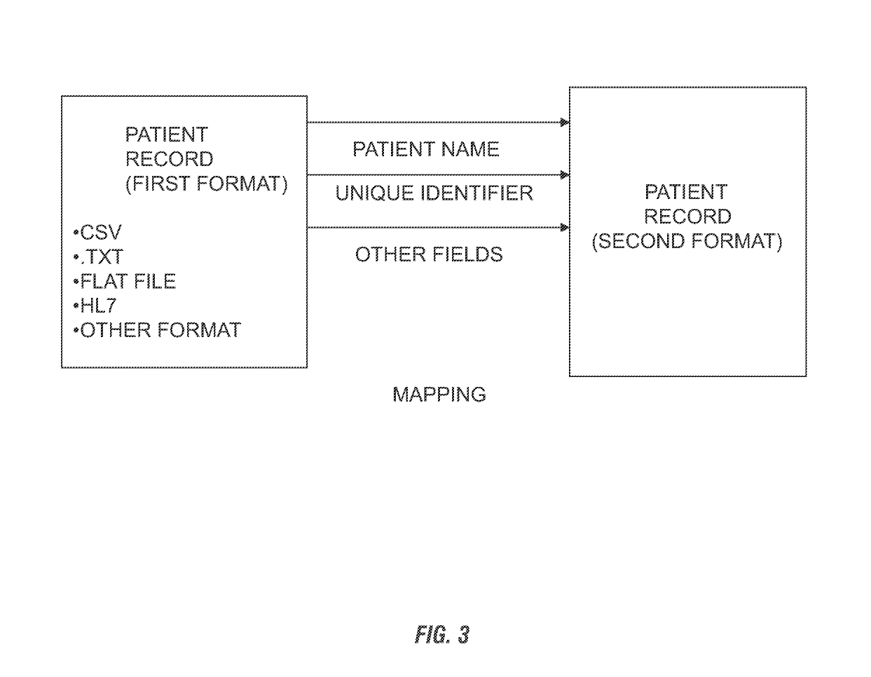

FIG. 3 illustrates one example of the process of mapping patient data in a first format to patient data in a second format as a part of a conversion process. Note that the patient record in the first format can be in any number of formats such as CSV, .TXT, flat file, HL7, or other type of format. Information such as patient name and a unique identifier are then mapped to a patient record in the second format.

In a preferred embodiment, a practice configures an applet to connect to their practice management data. After a one-time configuration, patient records can uploaded on demand into the MMRPro application (available from MMR Global) so that patient bar codes can be immediately created for the purpose of scanning records into the patient's virtual chart, and so that patient records can be searched and retrieved from within the MMRPro application. This open integration will work with any file format including data export .csv, .txt, flat file or HL7. As a result, a “universal” patient record conversion tool is created which will work with any open data connectivity (ODBC) compliant data source, which may include most practice management systems as well as EHRs and PHRs.

It should be appreciated that various significant advantages can be achieved. For example, health care providers can easily convert from a paper-records based system to or towards an electronic system. Moreover, once in electronic form, patients can now access the records through the patient portal 32. Moreover, data already in a practice management system 14 format can be leveraged to avoid errors in a conversion process and reduce efforts required.

Thus, various methods and systems related to patient records and universal conversion thereof have been described. Although specific embodiments have been provided, the present invention is not to be limited to these embodiments, as the present invention contemplates numerous variations, options, and alternatives.

1. A system, comprising:
a health care provider computer operatively connected over a network to a web server, the web server providing a health care provider portal and an applet;
the applet configured to convert patient records in a first data format to patient records in a second data format associated with the health care provider portal.

2. The system of claim 1 wherein the first format is a data format associated with a practice management system.

3. The system of claim 1 wherein the first format is an electronic health record format.

4. The system of claim 1 wherein the first format is a personal health record format.

5. A web server programmed to provide over a network connection, a health care provider portal to a health care provider and an applet to the health care provider wherein the applet is configured to convert patient records from a first data format associated with a health care practice management system of the health care practice to a second data format associated with the health care provided portal.

6. The web server of claim 5 wherein the health care provider portal being programmed to provide for creating cover sheets with bar codes using patient information stored in the second format.

7. The web server of claim 6 wherein the health care provider portal being programmed to correlate scanned paper records associated with the cover sheets and the corresponding bar codes with a unique patient identifier.

8. A method for converting paper records to electronic records, the method comprising:
executing an applet on a computer to access patient records stored in a first data format and convert the patient records to a second data format, wherein both the first format and the second format include a patient name and a unique patient identifier;
generating a bar code containing the unique patient identifier from the second format and printing the bar code on a second sheet;
scanning a plurality of paper pages comprising the cover sheet followed by at least one additional page of paper records associated with the patient identified with the unique patient identifier from the second format;
storing in data storage associated with and accessible by a web server an electronic copy of the at least one additional page of paper records such that the electronic copy is associated with the unique patient identifier.

9. The method of claim 8 further comprising making the electronic copy available to a health care provider using a health care provider computer operatively connected to the web server.

10. The method of claim 9 further comprising making the electronic copy available to a patient identified with the unique patient identifier using a computing device operatively connected to the web server.

11. The method of claim 8 wherein the first data format is associated with a health care practice management system of a health care provider.

12. The method of claim 11 wherein the second data format is associated with a health care provider web site portal.
